(19) United States
(12) Patent Application Publication
(10) Pub. No.: US 2009/0315468 A1
(43) Pub. Date: Dec. 24, 2009

(54) Light source driving circuit with dimming control function

(76) Inventors: Nian-Tzu Wu, Taipei City (TW); Dong-Min Chen, Taipei County (TW); Sheng-Shou Wang, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/260,098

(22) Filed: Oct. 29, 2008

(30) Foreign Application Priority Data
Jun. 18, 2008 (TW) 097122661

(51) Int. Cl. H05B 37/00

(52) U.S. Cl. 315/186

(57) ABSTRACT

A dimming control device is disclosed for controlling a switch of a voltage boosting circuit to output voltage or not so as to control the lumen of the set of LEDs utilizing the voltage boosting circuit. The dimming control device includes a switch. The switch of the dimming control device receives a dimming signal and accordingly controls “ON” or “OFF” states of the switch of the voltage boosting circuit. In this way, the period of a predetermined current flowing through the set of the LEDs can be adjusted and the lumen of the set of the LEDs is adjusted.

### BACKGROUND OF THE INVENTION

1. Field of the Invention

The invention relates to a light source driving circuit for controlling the luminance, and more particularly, to a light source driving circuit for controlling the luminance of a light source by controlling the switch of the light source driving circuit.

2. Description of the Prior Art

Please refer to FIG. 1 as the schematic diagram illustrating the conventional light source driving circuit 100 for dimming control. The light source driving circuit 100 is utilized to drive a load 110. The light source driving circuit 100 drives the load 110 by voltage boosting. The load 110 can be composed of several Light Emitting Diodes (LED) connected in series for receiving the output voltage V_{OUT} and output current I_{LOAD} of the light source driving circuit 100, so as to provide the luminance as desired. The brightness of the LED is positive related to the current passing through, so the current I_{LOAD} is positive related to the brightness of the load 110. Hereinafter detail description of the voltage boosting process in conventional structure is explained.

The light source driving circuit 100 comprises a capacitor C₁, a diode D₁, a inductor L₁, a switch Q₁, a feedback resistor R_{FB}, a duty ratio adjustor 120, an error amplifier 130, a compensation circuit 140, and a dimming control device 150. The diode D₁ can be a Schottky diode. The switch Q₁ can be an N-type Metal Oxide Semiconductor (NMOS) transistor. The switch Q₁ is named as the transistor Q₁ hereinafter.

The duty ratio adjustor 120 generates a switch control signal S_{PWM} according to the error amplifier 130 and the compensation circuit 140.

The error amplifier 130 comprises a positive port, a negative port and an output port. The error amplifiers 30 outputs an error current I_{X} through the output port of the error amplifier according to the voltage difference between signals received on the positive and the negative input ports of the error amplifier 130. The value and polarity of the error current I_{X} relate to the voltage difference between the signals received on the positive and negative input ports of the error amplifier 130.

The compensation circuit 140 comprises a resistor R_{X} and a capacitor C_{X}. A first end of the resistor R_{X} is electrically connected to a second end of capacitor C_{X}; a second end of resistor R_{X} is electrically connected to the ground end. A first end of capacitor C_{X} is electrically connected to the output port of the error amplifier 130 for receiving error current I_{X}; a second end of capacitor C_{X} is electrically connected to the first end of resistor R_{X}. The compensation circuit 140 composed of resistor R_{X} and capacitor C_{X} is utilized for receiving error current I_{X} outputted from the error amplifier 130, so as to adjust duty voltage V_{DUTY}. In other words, the duty voltage V_{DUTY} increases (charging the resistor R_{X} and the capacitor C_{X}) when the value of error current I_{X} outputted from the output port of the error amplifier 130 is positive; duty voltage V_{DUTY} decreases (discharging the resistor R_{X} and the capacitor C_{X}) when the value of error current I_{X} outputted from the output port of the error amplifier 130 is negative.

A first end of the inductor L₁ is electrically connected to an input voltage source; a second end of the inductor L₁ is electrically connected to a second end (drain) of the transistor Q₁. The inductor L₁ is disposed for receiving the voltage V_{IN} from the input voltage source.

The second end (drain) of the transistor Q₁ is electrically connected to the second end of the inductor L₁; a first end of the transistor Q₁ (source) is electrically connected to a ground end; a control end of the transistor Q₁ (gate) is electrically connected to the duty ratio adjustor 120 for receiving the switch control signal S_{PWM}. More particularly, the control end of the transistor Q₁ (Gate) is electrically connected to the output port of comparator 122 of the duty ratio adjustor 120 for receiving the switch control signal S_{PWM}. The transistor Q₁ is turned off when the switch control signal S_{PWM} is logic “0” (low voltage level), which is the first end (source) of the transistor Q₁ and the second end (drain) of the transistor Q₁ are disconnected. The transistor Q₁ is turned on when the switch control signal S_{PWM} is logic “1” (high voltage level), which is the first end (source) of the transistor Q₁ and the second end (drain) of transistor Q₁ are connected.

A positive end of the diode D₁ is electrically connected to the second end of the inductor L₁ and the first end of the transistor Q₁; a negative end of the diode D₁ is electrically connected to the first end of the capacitor C₁.

A first end of the capacitor C₁ is electrically connected to the negative end of the diode D₁; a second end of the capacitor C₁ is electrically connected to the ground end. The first end of the capacitor C₁ is utilized as the output port of the light source driving circuit 100 for outputting voltage V_{OUT}.

A first end of the load 110 is electrically connected to the output port of the light source driving circuit 100 (the first end of the capacitor C₁); a second end of the load 110 is electrically connected to the first end of the feedback resistor R_{FB}. The load 110 receives the voltage V_{OUT} and the load current I_{LOAD} accordingly passes through.

A first end of the feedback resistor R_{FB} is electrically connected to the second end of the load 110 and the negative input port of the error amplifier 130; a second end of the feedback resistor R_{FB} is electrically connected to the ground end. The feedback resistor R_{FB} receives the load current I_{LOAD}, generates the feedback voltage V_{FB} accordingly, and inputs the feedback voltage V_{FB} to the negative port of error amplifier 130. Thus, the error amplifier 130 determines the value of the load current I_{LOAD} on the load 110 according to the voltage V_{FB}.

A positive port of the error amplifier 130 is electrically connected to a reference voltage source for receiving a reference voltage V_{REF}; a negative port of the error amplifier 130 is electrically connected to the first port of the feedback resistor R_{FB} for receiving the feedback voltage V_{FB}; an output port of the error amplifier 130 is electrically connected to duty ratio adjustor 120 and the compensation circuit 140. More particularly, the output port of the error amplifier 130 is electrically connected to the first end of the resistor of the compensation circuit 140 and the duty ratio adjustor 120. The error amplifier 130 outputs the corresponding error current I_{X} according to the voltage difference between the reference voltage V_{REF} and the feedback voltage V_{FB}. More particularly, when the feedback voltage V_{FB} is lower than the reference voltage V_{REF}, the error current Iₓ outputted from the error amplifier 130 is positive, and is proportional to the voltage difference between the feedback voltage V_{FB} and the reference voltage V_{REF}. In this way, the duty voltage V_{DUTY} is increased (the duty ratio is reduced so as to raise the output voltage V_{OUT}) by charging the compensation circuit 140. On the other hand, when the feedback voltage V_{FB} is higher than the reference voltage V_{REF}, the error current Iₓ outputted from the error amplifier 130 is negative, and is proportional to the voltage difference between the feedback voltage V_{FB} and the reference voltage V_{REF}. In this way, the duty voltage V_{DUTY} is decreased (the duty ratio is increased so as to reduce the output voltage V_{OUT}) by discharging the compensation circuit 140. The error current I_{X} is calculated by the following equation:

I_{X}=G₁₃₀×(V_{REF}−V_{FB}) (1);

where G₁₃₀ represents the trans-conductance gain of the error amplifier 130.

According to the duty voltage V_{DUTY}, the duty ratio adjustor 120 adjusts the duty ratio of the switch control signal S_{PWM}.

Thus, when the feedback voltage V_{FB} is higher than the reference voltage V_{REF}, it means the value of load current I_{LOAD} is higher than the predetermined value, so that the error amplifier 130 outputs the error current I_{X} to the compensation circuit 140 for increasing the duty voltage V_{DUTY}. In this way, the duty ratio adjustor 120 outputs switch control signal S_{PWM} with lower duty ratio. Consequently, the transistor Q₁ reduces the period of being turned on because of the lower duty ratio of the switch control signal S_{PWM}. Therefore, the output voltage V_{OUT} of light source driving circuit 100 decreases, so as to reduce the load current I_{LOAD} to the predetermined value.

On the other hand, when the feedback voltage V_{FB} is lower than the reference voltage V_{REF}, it means the load current I_{LOAD} is lower than the predetermined value, the error amplifier 130 outputs the error current I_{X} to the compensation circuit 140 for decreasing the duty voltage V_{DUTY}. In this way, the duty ratio adjustor 120 outputs switch control signal S_{PWM} with the higher duty ratio. Consequently, the transistor Q₁ increases the period of being turning on because of the higher duty ratio of the switch control signal S_{PWM}. Therefore, output voltage V_{OUT} of the light source driving circuit 100 increases, so as to raise the load current I_{LOAD} to the predetermined value.

The dimming control device 150 comprises two dimming control resistors, R_{DIM1}, and R_{DIM2}, and a dimming control capacitor C_{DIM}. A first end of dimming control resistor R_{DIM1} is electrically connected to the negative input end of the error amplifier 130; a second end of dimming control resistor R_{DIM1} is electrically connected to a first end of dimming control capacitor C_{DIM}. The first end of dimming control capacitor C_{DIM} is electrically connected to the second end of dimming control resistor R_{DIM1}; a second end of dimming control capacitor C_{DIM} is electrically connected to the ground end. A first end of dimming control resistor R_{DIM2} is electrically connected to the second end of dimming control resistor R_{DIM1} and the first end of dimming control capacitor C_{DIM}; a second end of dimming control resistor R_{DIM2} receives a dimming control signal S_{DIM}. The dimming control signal S_{DIM} is a signal of Pulse Width Modulation (PWM). The dimming control signal S_{DIM} can adjust the feedback voltage V_{FB} by the dimming control resistors R_{DIM1}, and R_{DIM2}, and dimming control capacitor C_{DIM}, so as to affect the output current I_{X} of the error amplifier 130 for determining the output voltage V_{OUT}. By the method mentioned above, the dimming control signal S_{DIM} can adjust the load current I_{LOAD} of the load 110, so as to adjust the luminance of the load 110 for dimming control. More particularly, luminance of the load 110 increases as the duty ratio of the dimming control signal S_{DIM} increases. On the other hand, luminance of the load 110 decreases as the duty ratio of the dimming control signal S_{DIM} decreases.

However, the frequency of dimming control signal S_{DIM} is limited by the responding speed of the error amplifier 130, dimming control resistors, R_{DIM1}, and R_{DIM2}, and the dimming control capacitor C_{DIM}. That is, the feedback voltage V_{FB} adjusted by dimming control signal S_{DIM} must be a stable DC voltage for avoiding instability of the error amplifier 130. In other words, all of the impedances of dimming control resistors R_{DIM1}, and R_{DIM2}, and dimming control capacitor C_{DIM} have to be large enough for allowing feedback voltage V_{FB} to be a stable DC voltage if the frequency of the dimming control signal S_{DIM} is quite low. In this way, the feedback voltage V_{FB} adjusted by dimming control signal S_{DIM} can be still stable. Therefore, under such condition, it is inconvenient for users since the volume of the dimming control capacitor will be very large. Consequently, the frequency of the dimming control signal S_{DIM} has to be in a certain range high enough to make the volume of the dimming control capacitor C_{DIM} be acceptable for users. So the frequency of dimming control signal S_{DIM} is limited by the conventional light source driving circuit 100, which causes great inconvenience.

### SUMMARY OF THE INVENTION

The present invention provides a light source driving circuit with dimming control function. The light source driving circuit comprises an input end for receiving an input voltage, an inductor electrically connected to the input end, a diode electrically connected to the inductor, an output end electrically connected to the diode for outputting an output voltage, a load, a feedback resistor electrically connected between the second end of the load and a ground end, an error amplifier, a duty ratio adjustor electrically connected to the output end of the error amplifier for outputting a switch control signal, a first switch, and a dimming control device. The load comprises a first end electrically connected to the output end of the light source driving circuit, and a second end. The error amplifier comprises a positive end for receiving a reference voltage, a negative end electrically connected to the feedback resistor for receiving a feedback voltage, and an output end. The error amplifier outputs an error current according to the difference between the reference voltage and the feedback voltage. The first switch comprises a first end electrically connected to the inductor, a second end electrically connected to the ground end, and a control end electrically connected to the duty ratio adjustor for electrically connecting the first end of the first switch to the second end of the first switch according to the switch control signal. The dimming control device comprises a second switch. The second switch comprises a first end electrically connected to the output end of the error amplifier, a second end electrically connected to the ground end, and a control end for receiving a dimming control signal, the second switch electrically connecting the first end of the second switch to the second end of the second switch according to the dimming control signal.

The present invention further provides a dimming control device for adjusting luminance of the load of a light source driving circuit. The light source driving circuit comprises an input end, an inductor, a diode, an output end, the load, a capacitor, a feedback resistor, an error amplifier, a duty ratio adjustor, a first switch and a compensation circuit. The input end of the light driving circuit receives an input voltage. The inductor is electrically connected to the input end of the light source driving circuit. The diode is electrically connected to the inductor. The output end of the light source driving circuit is electrically connected to the diode for outputting the output voltage. The load comprises a first end electrically connected to the output end of the light source driving circuit and a second end. The feedback resistor is electrically connected between the second end of the load and the ground end. The error amplifier comprises a positive input end for receiving a reference voltage, a negative input end electrically connected to the feedback resistor for receiving a feedback voltage, and an output end. The error amplifier generates an error current according to the difference between the reference voltage and the feedback voltage. The compensation circuit is electrically connected between the output end of the error amplifier and the ground end for generating a duty voltage according to the error current generated by the error amplifier. The duty ratio adjustor is electrically connected to the output end of the error amplifier for outputting a switch control signal. The first switch comprises a first end electrically connected to the inductor, a second end electrically connected to the ground end, and a control end electrically connected to the duty ratio adjustor for electrically connecting the first end of the switch to the second end of the switch according to the switch control signal. The dimming control device comprises a second switch. The second switch comprises a first end electrically connected to the output end of the error amplifier, a second end electrically connected to the ground end, and a control end for receiving a dimming control signal, wherein the second switch electrically connects the first end of the second switch to the second end of the second switch according to the dimming control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the conventional light source driving circuit for dimming control.

FIG. 2 is a schematic diagram of the present invention illustrating the light source driving circuit with dimming control function.

FIG. 3 is a timing diagram illustrating when the present invention of the light source driving circuit with the dimming control function adjusting luminance.

### DETAILED DESCRIPTION

Some vocabularies are used to present specified components in the description and claims hereinafter. Manufacturers may name these components by different vocabularies, but it will be understandable with common sense of the domain. The present description and claims hereinafter will differ components by functions rather than by name. The word “comprise” mentioned in the whole description and claims hereinafter will be interpreted as “comprise but not specify” Further more, the phrase “electrically connection” includes any direct and indirect electrically connections. Thus, if the description goes as “the device A is electrically connected to the device B”, it means the device A can be coupled to the device B directly or by other indirect means and devices.

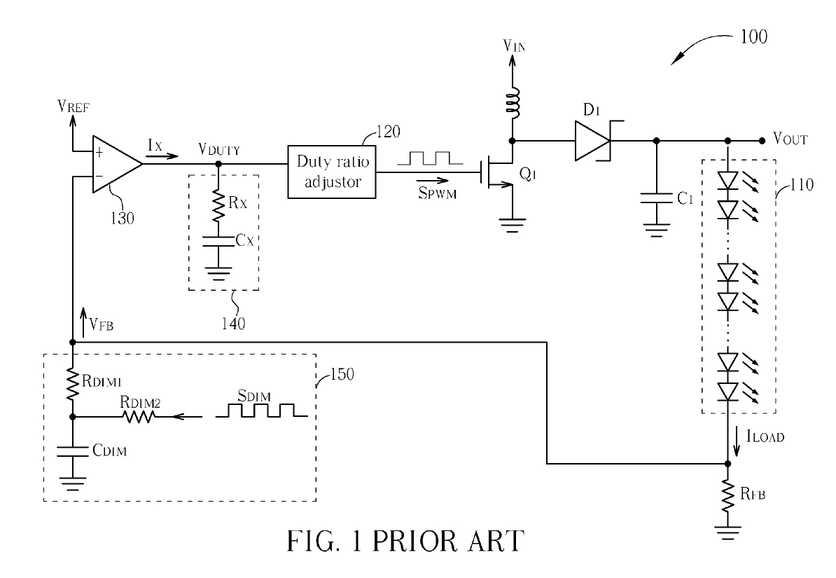

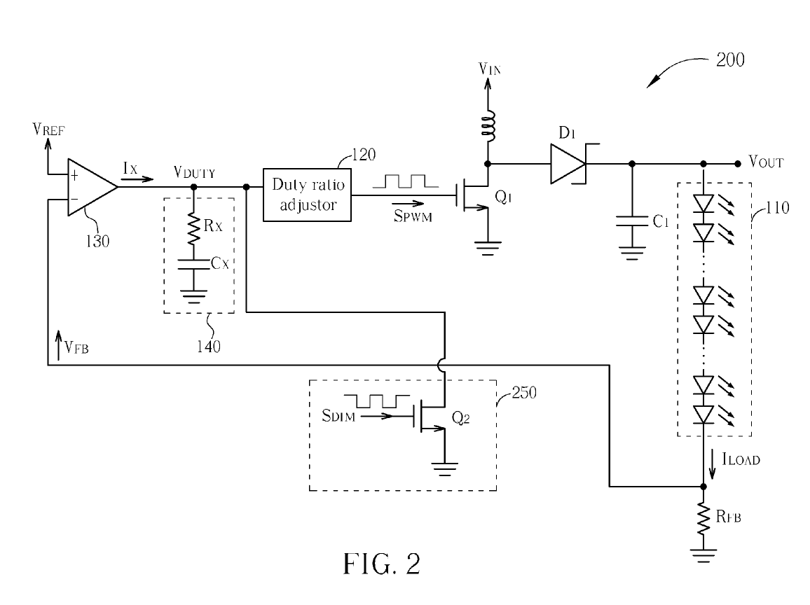

Please refer to FIG. 2. FIG. 2 is a schematic diagram of the present invention illustrating the light source driving circuit 200 with dimming control function. The light source driving circuit 200 of FIG. 2 is similar to the one in FIG. 1 except the dimming control device 250, so the related functions for the elements of the light source driving circuit 200 which are identical to those of the light source driving circuit 100 will not stated herein. In FIG. 2, the light source driving circuit 200 of the present invention replaces the conventional dimming control device 150 with the dimming control device 250. Further description of the dimming control device 250 is explained hereinafter.

The dimming control device 250 comprises a switch Q₂. The switch Q₂ comprises a first end (source) electrically connected to the ground end, a second end (drain) electrically connected to the input end of the duty ratio regulator 120 (the output end of the error amplifier 130), a control end (gate) for receiving the dimming control signal S_{DIM}. The switch Q₂ can be an N-type Metal Oxide Semiconductor (NMOS) transistor, and the switch Q₂ hereinafter is named as a transistor Q₂. When the dimming control signal S_{DIM} is logic “0” (low voltage level), the transistor Q₂ is turned off. In other words, the first end (source) of the transistor Q₂ is electrically disconnected from the second end (drain) of the transistor Q₂ when the dimming control signal S_{DIM} is logic “0”. Therefore, the signal received by the control end of the transistor Q₁ is the switch control signal S_{PWM}, and the output voltage V_{OUT} is determined according to the switch control signal S_{PWM}. When the dimming control signal S_{DIM} is logic “1”, the transistor Q₂ is turned on. Thus, the voltage V_{DUTY} on the output end of the error amplifier 130 is pulled down to a low voltage, which means the switch control signal S_{PWM} is kept at a low voltage, so as to keep the transistor Q₁ off and not to output the output voltage V_{OUT}. In this way, the user can adjust the duty ratio of the dimming control signal S_{DIM} to determine the ratio of the switching on/off periods of the output voltage V_{OUT} for determining the luminance. In other words, assuming the output voltage V_{OUT} is the predetermined voltage V₁ and the load current I_{LOAD} is the predetermined current I₁, the light source driving circuit 200 outputs the voltage V₁ and the current I₁, when the dimming control signal is logic “0”; the light source driving circuit outputs 0 volt and 0 amp when the dimming control signal is logic “1”.

Since the dimming control device 250 electrically connected to the input end of the duty ratio regulator 120 (the output end of the error amplifier 130), no frequency limitation exists to the dimming control signal of the light source circuit of the present invention. In this way, the frequency of the dimming control signal S_{DIM} can be adjusted as desired, which provides great convenience.

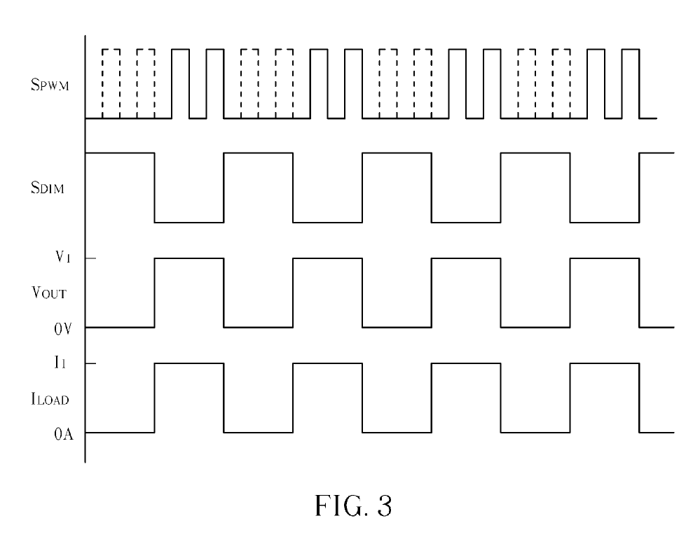

Please refer to FIG. 3. FIG. 3 is a timing diagram illustrating when the present invention of the light source driving circuit with the dimming control function adjusting luminance. As shown in FIG. 3, when the dimming control signal S_{DIM} is logic “0”, the switch control signal S_{PWM} is input to the transistor Q₁, which allows the light source driving circuit 200 to output voltage V₁. Meanwhile, the load 110 emits light with the load current I₁ passing through. When the dimming control signal S_{DIM} is logic “1”, the switch control signal S_{PWM} is kept at a low voltage, so as to cause the transistor Q₁ to remain off, and thus the output voltage V_{OUT} becomes 0 volt and the load current I_{LOAD} becomes 0 amp, Consequently, the load 110 emits no light. It is understood that as shown in FIG. 3, users can adjust duty ratio of the dimming control signal S_{DIM} to determine the periods of the load current I_{LOAD} being I₁ and 0 amp. The ratio of the two periods aforementioned can be the basis for adjusting the luminance. When the duty ratio of the dimming control signal S_{DIM} is increased, the period of the load current I_{LOAD} being I₁ is increased as well. By averaging the increased period of the load current I_{LOAD} being I₁ and the period of the load current I_{LOAD} being 0 amp, users can obtain the higher luminance of the load 110. when the duty ratio of the dimming control signal S_{DIM} is decreased, the period of the current I_{LOAD} being I₁ is decreased as well. By averaging the decreased period of the load current I_{LOAD} being I₁ and the period of the load current I_{LOAD} being 0 amp, users can obtain the lower luminance of the load 110.

Summarize all, the dimming control device and the light source driving circuit provided by the present invention, provide users to adjusting luminance of the load without frequency limitation, which increases convenience.

Those skilled in the art will readily observe that numerous modifications and alterations of the device and method may be made while retaining the teachings of the invention.

What is claimed is:

1. A light source driving circuit with dimming control function, the light source driving circuit comprising:
an input end for receiving an input voltage;
an inductor electrically connected to the input end;
a diode electrically connected to the inductor;
an output end electrically connected to the diode for outputting an output voltage;
a load, comprising:
a first end electrically connected to the output end of the light source driving circuit; and
a second end;
a feedback resistor electrically connected between the second end of the load and a ground end;
an error amplifier, comprising:
a positive end for receiving a reference voltage;
a negative end electrically connected to the feedback resistor for receiving a feedback voltage; and
an output end, the error amplifier outputting an error current according to the difference between the reference voltage and the feedback voltage;
a duty ratio adjustor electrically connected to the output end of the error amplifier for outputting a switch control signal;
a first switch, comprising:
a first end electrically connected to the inductor;
a second end electrically connected to the ground end; and
a control end electrically connected to the duty ratio adjustor for electrically connecting the first end of the first switch to the second end of the first switch according to the switch control signal; and
a dimming control device, comprising:
a second switch, comprising:
a first end electrically connected to the output end of the error amplifier;
a second end electrically connected to the ground end; and
a control end for receiving a dimming control signal, the second switch electrically connecting the first end of the second switch to the second end of the second switch according to the dimming control signal.

2. The light source driving circuit of claim 1, wherein the load is a plurality of light emitting diodes connected in series.

3. The light source driving circuit of claim 1, wherein the first switch is an N-type Metal Oxide Semiconductor (NMOS) transistor.

4. The light source driving circuit of claim 1, wherein the second switch is an NMOS transistor.

5. The light source driving circuit of claim 1, further comprising a capacitor electrically connected between the diode and the ground end.

6. The light source driving circuit of claim 1, further comprising a compensation circuit electrically connected between the output end of the error amplifier and the ground end for generating a duty voltage according to the error current generated from the error amplifier.

7. The light source driving circuit of claim 6, wherein the compensation circuit comprises:
a resistor electrically connected to the output end of the error amplifier; and
a capacitor electrically connected between the resistor of the compensation circuit and the ground end.

8. The light source driving circuit of claim 1, wherein when the dimming control signal is at a high voltage level, the second switch electrically connects the second end of the second switch to the first end of the second switch for keeping the switch control signal being at a low voltage.

9. The light source driving circuit of claim 1, wherein when the dimming control signal is at a low voltage level, the second switch electrically disconnects the second end of the second switch from the first end of the second switch.

10. A dimming control device, for adjusting luminance of the load of a light source driving circuit, the light source driving circuit comprising an input end, an inductor, a diode, an output end, the load, a capacitor, a feedback resistor, an error amplifier, a duty ratio adjustor, a first switch and a compensation circuit, the input end of the light driving circuit receiving an input voltage, the inductor electrically connected to the input end of the light source driving circuit, the diode electrically connected to the inductor, the output end of the light source driving circuit electrically connected to the diode for outputting the output voltage, the load comprising a first end electrically connected to the output end of the light source driving circuit and a second end, the feedback resistor electrically connected between the second end of the load and the ground end, the error amplifier comprises a positive input end for receiving a reference voltage, a negative input end electrically connected to the feedback resistor for receiving a feedback voltage, and an output end, the error amplifier generating an error current according to the difference between the reference voltage and the feedback voltage, the compensation circuit electrically connected between the output end of the error amplifier and the ground end for generating a duty voltage according to the error current generated by the error amplifier, the duty ratio adjustor electrically connected to the output end of the error amplifier for outputting a switch control signal, the first switch comprising a first end electrically connected to the inductor, a second end electrically connected to the ground end, and a control end electrically connected to the duty ratio adjustor for electrically connecting the first end of the switch to the second end of the switch according to the switch control signal, the dimming control device comprises:
a second switch comprising:
a first end electrically connected to the output end of the error amplifier;
a second end electrically connected to the ground end; and
a control end for receiving a dimming control signal, wherein the second switch electrically connects the first end of the second switch to the second end of the second switch according to the dimming control signal.

11. The dimming control device of claim 10, wherein the load is a plurality of light emitting diodes(LED) connected in series.

12. The dimming control device of claim 10, wherein the first switch is an N-type Metal Oxide Semiconductor(NMOS) transistor.

13. The dimming control device of claim 10, wherein the second switch is an N-type Metal Oxide Semiconductor(NMOS) transistor.

14. The dimming control device of claim 10, further comprising a capacitor electrically connected between the diode and the ground end.

15. The dimming control device of claim 10, further comprising a compensation circuit electrically connected between the output end of the error amplifier and the ground end for generating a duty voltage according to the error current generated by the error amplifier.

16. The dimming control device of claim 15, wherein the compensation circuit comprises:
a resistor electrically connected to the output end of the error amplifier; and
a capacitor electrically connected between the resistor of the compensation circuit and the ground end.

17. The dimming control device of claim 10, wherein when the dimming control signal is a high voltage level, the second switch electrically connects the second end of the second switch to the first end of the second switch for keeping the switch control signal being at a low voltage.

18. The dimming control device of claim 10, wherein when the dimming control signal is a low voltage level, the second switch electrically disconnects the second end of the second switch to the first end of the second switch.
